(19) United States
(12) Patent Application Publication
(10) Pub. No.: US 2013/0055205 A1
(43) Pub. Date: Feb. 28, 2013

(54) FILTERING SOURCE CODE ANALYSIS RESULTS

(71) Applicants: Damien Sereni, London (GB); Torbjorn Ekman, London (GB)

(72) Inventors: Damien Sereni, London (GB); Torbjorn Ekman, London (GB)

(73) Assignee: SEMMLE LIMITED, Oxford (GB)

(21) Appl. No.: 13/215,637

(22) Filed: Aug. 23, 2011

(51) Int. Cl. G06F 9/44

(52) U.S. Cl. 717/124

(57) ABSTRACT

A novel system, computer program product and method and system is provided for filtering the results of a source code analysis tool to present only the most relevant results to a user. A source code analysis tool is used to detect problems in source code files. Of the problems that are detected, some may be irrelevant to a user, making it harder for the user to interpret the results. The present invention removes some of the detected problems, presenting the user with a smaller set of problems to consider. The problems may be filtered by removing problems in files that have not been modified for a certain period of time. In addition, the problems may also be filtered by removing problems in files that have been modified by fewer than a given number of people. The problems may also be filtered by removing problems that occur in third-party source code.

### CROSS-REFERENCE TO RELATED APPLICATIONS

Not applicable.

### FIELD OF THE INVENTION

The present invention generally relates to analysis of software, and more particularly to the detection and reporting of defects in source code.

### BACKGROUND OF THE INVENTION

It is well known that software source code contains problems that make it difficult to add functionality to the software, or to modify existing functionality. Examples of such problems include errors in the source code, the structure of the code being inadequate for the desired changes, and source code that is correct when executed by a computer but is nonetheless confusing for a human reader. As it is estimated that a majority of the time spent developing software is spent reading and understanding existing source code, detecting and addressing readability problems is of paramount importance in software development.

Many analysis tools that detect such problems have been created. These tools can detect problems in the source code without requiring the code to be executed, and can report the problems in order to improve the code.

However, a common problem with source code analysis tools is that a large number of results are typically reported on most source code. Due to limitations of source code analysis, some of these results can be incorrect. In addition, even when the problems that are detected are correct, a user may not consider the problems relevant.

For example, a tool may report that a part of the source code would be difficult for a human to read and modify, but unless this part of the code is modified then the reported problem is useless to the user. An example of a problem that is useful to report only if the code is modified is a single function that is too long. Many guidelines for writing good code recommend that a single function should consist of at most 200 lines of source code, and it is useful to report violations of these guidelines to a user. However, this is only relevant if the function is located in a part of the code that the user intends to modify in some way.

In another example, a tool may report problems in a part of the source code that is not developed by the user. One situation in which this may occur is if the source code includes some open-source components that are used, but are developed by a different set of developers. In this case, problems in the open-source components are typically not of interest to a user of the tool.

It is difficult for users of a source code analysis tool to find which of the problems reported by a tool are most important to them and therefore should be fixed most urgently.

### SUMMARY OF THE INVENTION

Systems and methods are provided that take a collection of problems in source code that are detected by a source code analysis tool, and produce a smaller collection of problems that include some, but not all of the problems reported by a source code analysis tool. This is achieved by determining for each problem reported by the source code analysis tool whether it should be included or discarded. The resulting collection of problems can be presented to a user in a variety of ways.

The methods for choosing which of the problems to include and which to discard ensure two important properties: first, the resulting set of problems is typically significantly smaller than the set of problems originally reported by the source code analysis tool; and second, the problems that are reported would be considered relevant by a user of the tool.

The methods for choosing relevant problems are able to make use of the source code itself, as well as other important information such as the dates and times at which parts of the source code have been modified. This information helps adapt the choice of relevant problems by detecting which parts of the source code are actively being modified by a user at the time that a tool is used to detect problems. By only showing a user those problems in parts of the source code that are being modified, a smaller and more relevant set of problems is identified. Such information can be made available by a version control system.

In addition, if desired the methods for choosing relevant problems can also be given as input any external components that are part of the source code, but are not of interest to the user. In this case, the methods described herein can detect any problems that occur in these components in order to discard these problems. Because it is common for source code for external components to be modified, the method for filtering is robust in that it can detect which parts of the source code has been modified, and which parts have been used without modification.

### BRIEF DESCRIPTION OF THE DRAWINGS

FIG. 1 is a functional block diagram depicting how the present invention may be used in to filter results of a source code analysis tool.

FIG. 2 is a functional block diagram depicting how two or more of the filtering modules can be chained to further filter results of a source code analysis tool.

FIG. 3 is a flow diagram for filtering source code analysis results, where results are rejected if they are located in files that have not been edited for a settable period of time.

FIG. 4 is a flow diagram for filtering source code analysis results, where results are rejected if they are located in files that have been edited by fewer than a given number of people.

FIG. 5 is a flow diagram of another example for filtering source code analysis results, where results are rejected if the line containing the result has a matching line in a given third-party source code.

FIG. 6 is a functional block diagram illustrating how the method described in FIG. 5 matches lines between files in different codebases

FIG. 7 is a flow diagram for filtering source code analysis results, where results are rejected if they are located in files where no new results were added in a certain time period.

FIG. 8 is a block diagram of a computer system useful for implementing the filtering module.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

The novel system, computer program product, and method disclosed filters the results of a source code analysis tool to present a user with a small subset of a tool's results so that all the problems that are presented to the user are relevant to them. The filtering module of disclosed herein uses both criteria about the source code itself e.g. age, whether it is third-party code, how many unique users have edited the code as well as the source code itself.

### DEFINITIONS

A source code file is any textual file that can be interpreted by a computer program to cause the program to execute any instructions described in the file, or that can be translated into a binary representation that can be executed by a computer. Source code files may contain text as well as instructions; an example of this is a web page containing text as well as executable code.

A codebase is any set of source code files.

A file is a portion of source code for a computer program.

A source code analysis tool is any computer program that takes as input source code files, possibly with some other information, and outputs a collection of messages that are associated with particular locations in the source code files.

A source code analysis result is any message associated with a location in a source code file that is produced by a source code analysis tool.

A version control system is a computer program, or a component of a computer program, that stores files, allows users to retrieve or modify the files, and keeps a history of the changes that were made to the files.

Version history is the list of modifications recorded by a version control system.

Third-party source code refers to any source code files that are part of a codebase but have been written by people other than the authors of the rest of the codebase.

Architecture Overview

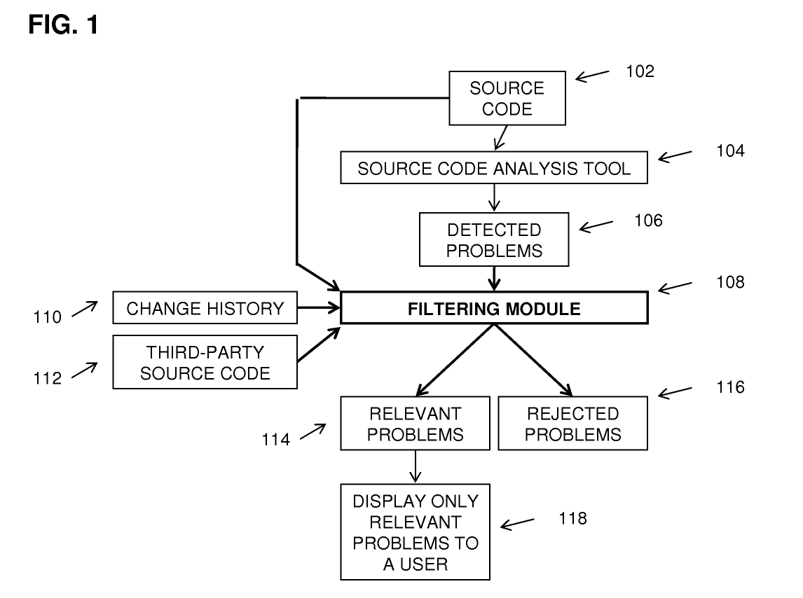

FIG. 1 describes the overall architecture of the present invention. A set of source code files (102) is given as input to a source code analysis tool (104). This results in a set of detected problems (106) that is passed as input i.e. “filtering input” to the present invention, namely the filtering module (108). The filtering module takes as additional inputs the following data sources: the source code (102) itself, the change history (110) corresponding to the source code, and if desired a set of third-party source code files (112). Given these inputs, the filtering module (108) produces a “filtering output” that is a subset of the source code analysis results. More specifically, the filtering module (108) classifies problems into two categories: the relevant problems (114) and the rejected problems (116). The rejected problems are simply discarded, while the relevant problems may be presented to the user in (118), through a variety of ways such as recording the relevant problems to a file, displaying the problems in a graphical user interface, or displaying the problems in a web page.

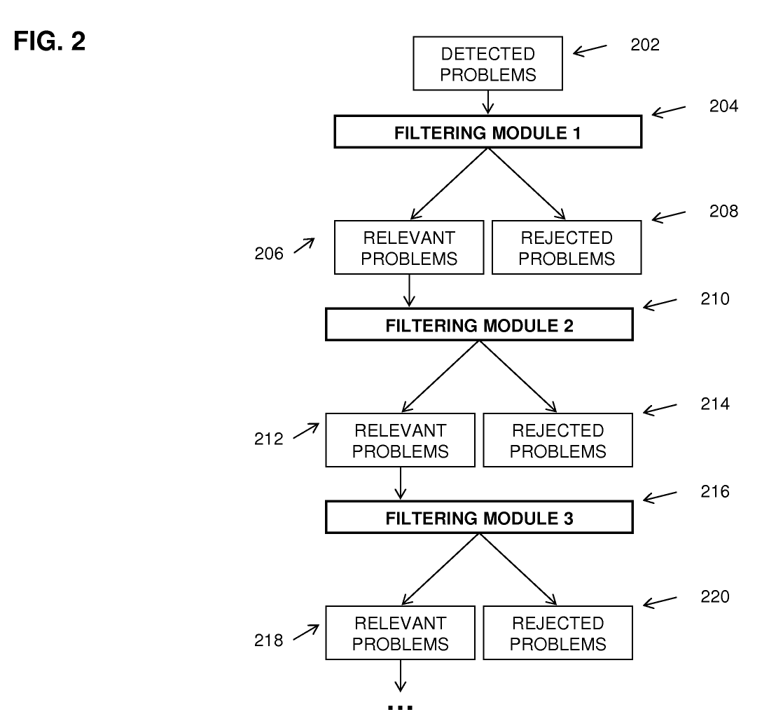

Several implementations of the filtering module depicted in (108) will be described in more details in the following text. Note first that the architecture may be extended to allow several filtering modules to be used as depicted in FIG. 2. In this case, several filtering modules are functionally coupled or chained in series (FIG. 2 illustrates three modules (204, 210 and 216), but any number of modules can be chained) to process a set of detected problems (202). Each filtering module may reject a problem (208, 214 and 220), and these problems are immediately rejected. However, problems that are classified as relevant by one module (206, 212) and 218) are passed to the next filtering module, if any. The net effect of this chaining of filtering modules is to reject any problem that is rejected by any of the filtering modules, and keep only problems that are marked as relevant by all filtering modules. This has the advantage of reducing the number of relevant problems yet further.

Filtering Modules

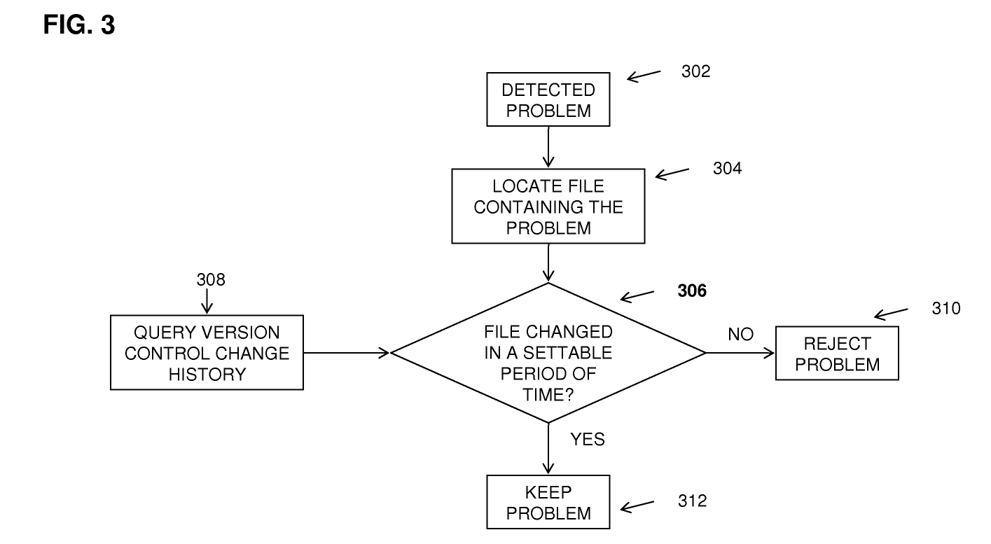

Each of FIGS. 3-5 and 7 should be understood to describe the implementation of one or more of the filtering modules illustrated as (204, 210) and (216). As such, the filtering module takes as input the set of detected problems, and produces a set of relevant problems and a set of rejected problems.

The filtering module in FIG. 3 processes the input problems one at a time, and operates on a single detected problem (302). The outcome is to either keep the problem (312), in which case the problem is added to the set of relevant problems, or to reject the problem (310), in which case it is added to the set of rejected problems.

To decide whether to keep or reject the problem (306), the filtering module first locates the file that contains the problem (304). It then retrieves from the version control system (308) the last date at which a change was made to the file. Retrieving the date from the version control system can be achieved by one of: running a program that is part of the version control system, using a library, or inspecting the log files produced by the version control system. The file is kept if the date of the last change is close enough to the current date when the filtering module is run: in the example figure, this is shown as the last change date being within 30 days of the current date, but the number of days can be changed, either by being configured by a user or in an implementation of the filtering module.

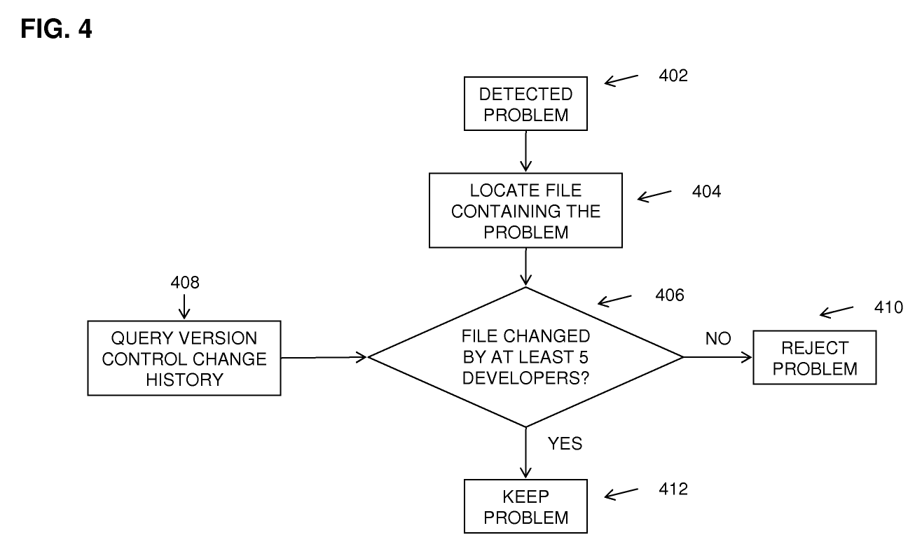

FIG. 4 is a flow diagram for filtering source code analysis results, where results are rejected if they are located in files that have been edited by fewer than a given number of people. This given number of people is a settable by the user. It is well known that files edited by many different users are more likely to contain errors, because it is less likely that all the users know the file well enough to make correct changes. Problems in these files are therefore more relevant than problems in files edited by few users.

The architecture of the filtering module in FIG. 4 is similar to the module depicted in FIG. 3, but the selection criterion is different. Once the file has been located, the version control system (408) is queried to retrieve the users that have modified the file. Each user is identified by a unique identifier in the version control system, which may be the email address of the user, a username or some other identifier—all that matters is that the user identifiers are unique. The filtering module then counts the number of distinct users that have at any point modified the file (404) and keeps the problem (412) if the file was modified by more than a specified number of users (406) otherwise the file is filtered-out (410). In the example in FIG. 4, the problem is kept if the file has been modified by at least 5 users, but this number can be changed, either by being configured by a user or in an implementation of the filtering module.

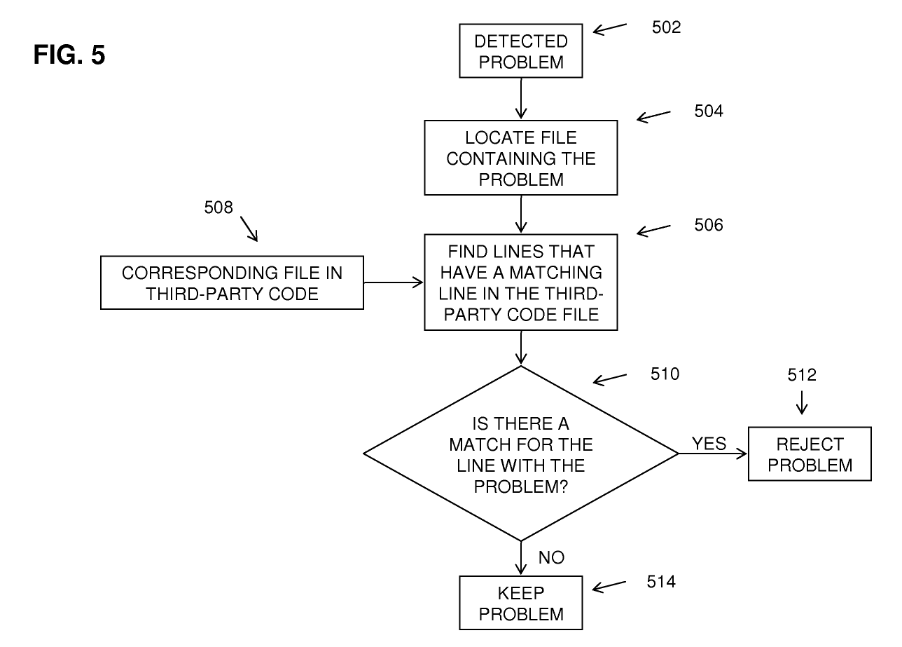

FIG. 5 is a flow diagram of another example for filtering source code analysis results, where results are rejected if the same line containing the result has a matching line in a given third-party source code.

This filtering module addresses the problem of third-party code: if a codebase contains some source code files that are derived from third-party code and are not considered part of the code, then problems in these files are not relevant. Furthermore, if a codebase contains files that are partially identical to third-party source files, then problems in the identical parts are not relevant, but problems in the parts that differ are relevant.

To illustrate this filtering module, consider as an example a codebase with three files A, B and C. Suppose further that A and B have been copied from an open-source project, but C was written from scratch. Finally, suppose that after being copied, B was modified in part. The filter will reject all problems identified in A; reject problems in B only if they are located on the same lines that have a corresponding line in the original version of B (before modifications); and keep all problems in C.

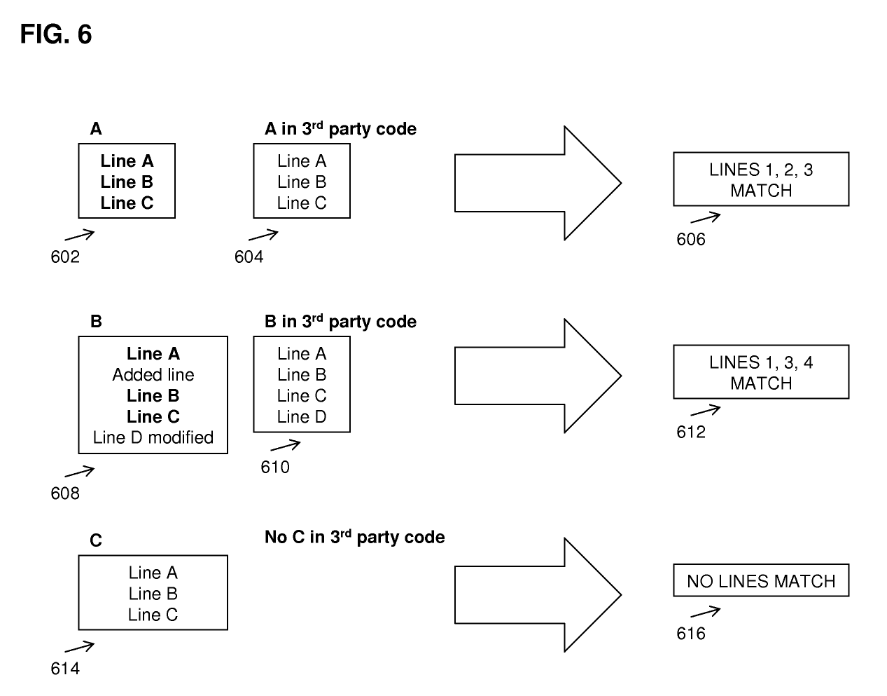

To achieve this, the filter in FIG. 5 follows the same two steps as the previous filters (502 and 504), but takes as its input the third-party codebase 508 to compare against. In the example, this would consist of files A and B. The key step in this filter is to detect matching lines between the third-party code and the files containing problems (506 and 510). Again we illustrate this with our example, in FIG. 6. First, File A (602) is matched to its counterpart in the open-source code (604). Since the files are identical, all lines match (606). File B (608) is also matched to its counterpart in the open-source code (610), but here not all the lines are the same: a line was added (with contents “Added line”) and line D was modified. Three of the lines are found to match: the lines numbered 1, 3 and 4 (612). Note that the line numbers correspond to lines in file B, not its counterpart in the open-source code. Finally, file C (614) is immediately excluded: it has no corresponding file in the open-source code, so there are no matching lines (514, 616) otherwise filter-out and reject (512). Those skilled in the art will appreciate that procedures for achieving this matching are well known and do not need to be described further.

A refinement of the matching procedure described in FIG. 6 uses the textual content of the source files at the location of a source code analysis result. The textual content is the sequence of characters in a source code file within the location of a source code analysis result on that file. In this refinement, a previous source code analysis result is matched to a source code analysis result at a different date on the same file if the textual contents of the two results are identical.

Using the matching procedure described above, the filtering module of FIG. 5 finds matching lines between the files (506). The filtering criterion is then to reject a problem if there is a matching line in the third-party codebase (510). To continue the previous example, a problem on any line of file A would be rejected, as would a problem located on line 1, 3 or 4 of file B.

A refinement of this filtering module is required if problems can span several lines. Each problem has a corresponding location in the source, which consists of all or part of one or more lines. In one example, if the location of a problem contains parts of several lines, then the problem is rejected only if all lines have a matching line as described above. In another example, the problem is rejected if any of the lines have a matching line as described above. It will readily be seen that variations on these criteria can be made without affecting the spirit of the invention.

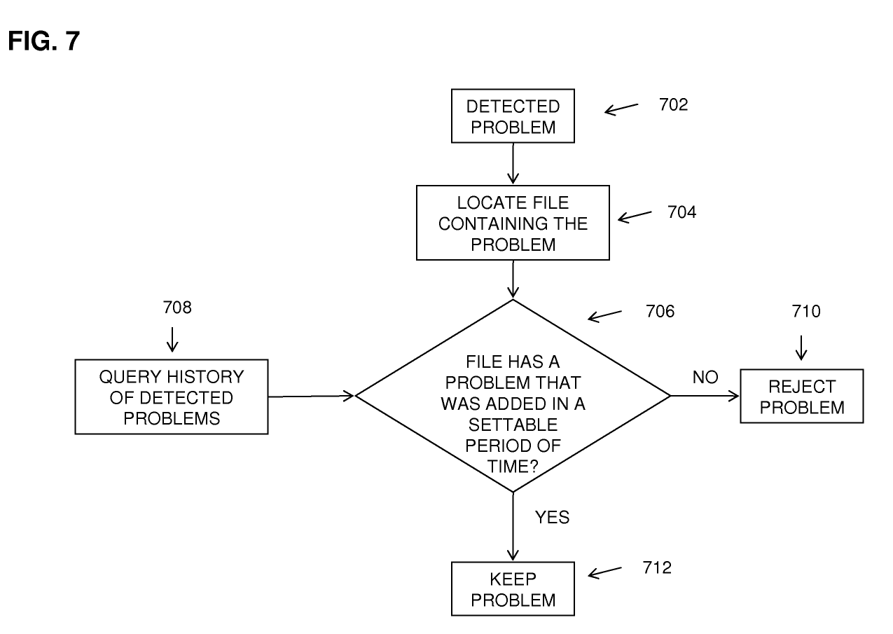

FIG. 7 is a flow diagram for filtering source code analysis results, where results are rejected if they are located in files where no new results were added in a certain time period. This filtering module can be seen as a stricter version of the module described in FIG. 3, in that it keeps fewer defects, but the module of FIG. 3 would also keep any defect kept by this module. This module rejects all problems unless a problem was recently introduced to the same file, so that the introduction of one new problem to a file immediately makes all problems in that file relevant.

This filtering module takes as input the history of detected problems (708). This is the list of the problems that were detected each time the source code analysis tool was run on the same codebase (704). For instance, if the source code analysis tool was run each day for three days in a row, the history of detected problems would contain the problems detected on each of the three days. The filtering module compares the number of detected problems for each day (706, 708), and if any new problem was detected in the file in the last 5 days, then all problems are kept (712); otherwise all problems are rejected (710). The duration of 5 days is an illustration, and the user can select any duration.

### Other Embodiments

While the above description of the invention applies to software source code, the invention can be used to provide the same filtering functionality to problems detected in artifacts other than source code. One example of such an example is to filter results of a text analysis tool (such as a spelling checker) running on a textual document such as documentation of software source code.

### Non-Limiting Hardware Examples

Overall, the present invention can be realized in hardware or a combination of hardware and software. The processing system according to one example can be realized in a centralized fashion in one computer system, or in a distributed fashion where different elements are spread across several interconnected computer systems and image acquisition sub-systems. Any kind of computer system—or other apparatus adapted for carrying out the methods described herein—is suited. A typical combination of hardware and software is a general-purpose computer system with a computer program that, when loaded and executed, controls the computer system such that it carries out the methods described herein.

In one example, the present invention can also be embedded in a computer program product, which comprises all the features enabling the implementation of the methods described herein, and which—when loaded in a computer system—is able to carry out these methods. Computer program means or computer programs in the present context mean any expression, in any language, code or notation, of a set of instructions intended to cause a system having an information processing capability to perform a particular function either directly or after either or both of the following a) conversion to another language, code or, notation; and b) reproduction in a different material form.

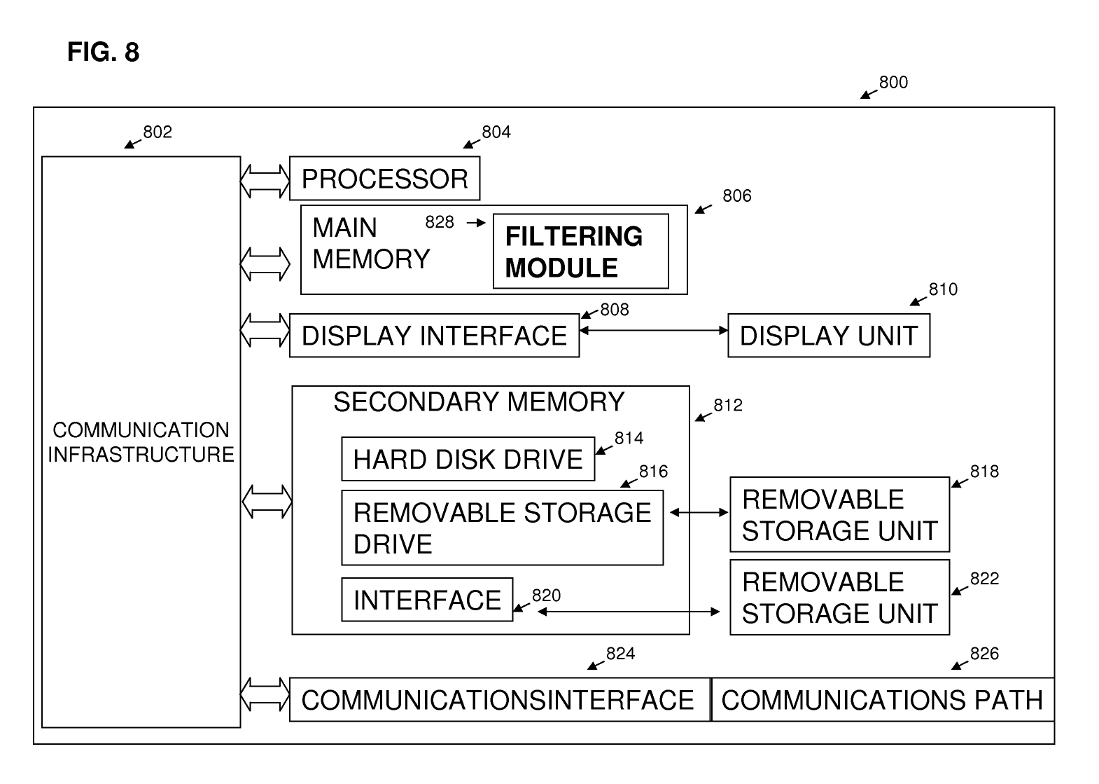

FIG. 8 is a block diagram of a computer system useful for implementing the filtering module. Computer system (800) includes a display interface (808) that forwards graphics, text, and other data from the communication infrastructure (802) (or from a frame buffer not shown) for display on the display unit (810). Computer system (800) also includes a processor (802) communicatively coupled to main memory (806), preferably random access memory (RAM), and optionally includes a secondary memory (812). The secondary memory (812) includes, for example, a hard disk drive (814) and/or a removable storage drive (816), representing a floppy disk drive, a magnetic tape drive, an optical disk drive, etc. The removable computer readable storage drive (816) reads from and/or writes to a removable storage unit 818 in a manner well known to those having ordinary skill in the art. Removable storage unit (818), represents a CD, DVD, magnetic tape, optical disk, etc. which is read by and written to by removable storage drive (816). As will be appreciated, the removable storage unit (818) includes a computer usable storage medium having stored therein computer software and/or data. The terms “computer program medium,” “computer usable medium,” and “computer readable medium” are used to generally refer to media such as main memory (806) and secondary memory (812), removable storage drive (816), a hard disk installed in hard disk drive (814), and signals.

Computer system (800) also optionally includes a communications interface 824. Communications interface (824) allows software and data to be transferred between computer system (800) and external devices. Examples of communications interface (824) include a modem, a network interface (such as an Ethernet card), a communications port, a PCMCIA slot and card, etc. Software and data transferred via communications interface (824) are in the form of signals which may be, for example, electronic, electromagnetic, optical, or other signals capable of being received by communications interface (824). These signals are provided to communications interface (824) via a communications path (i.e., channel) (826). This channel (826) carries signals and is implemented using wire or cable, fiber optics, a phone line, a cellular phone link, an RF link, and/or other communications channels.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A computer-implemented method for filtering results of a source code analysis tool, the method comprising:
accessing at least a portion of source code;
running a source code analysis tool on a computer system, wherein the source code analysis tool uses the portion of source code as an input and producing as an output a set of source code analysis results; and
running a filtering module using as a filtering input the set of source code analysis results, wherein the filtering module produces as a filtering output, a subset of the source code analysis results, using a filtering criteria related to the source code.

2. The method of claim 1, further comprising:
running a plurality of filtering modules coupled together in series with a first filtering output of a first filtering module used as a second filtering input of a second filtering module, thereby producing a series filtering output using both the first filtering module and the second filtering module.

3. The method of claim 1, further comprising:
retrieving a list of changes to the source code from a version control system, wherein each change in the list of changes includes a unique identifier, a set of files related to each change, a date, and an identifier associated with a user making the change.

4. The method of claim 3, wherein the filtering output of the filtering module includes the subset of the source code analysis results within a settable period of time.

5. The method of claim 3, wherein the filtering output of the filtering module includes the subset of the source code analysis results with a number of identifiers associated with distinct users making the change being greater than a settable number.

6. The method of claim 1, further comprising:
accessing at least a portion of third-party source code;
identifying one or more line of programming code in the source code that have a matching line of programming code in the third-party source code; and
in response to lines in the source code not matching any lines in the third-party source code, the filtering output of the filtering module includes the subset of the source code analysis results with any lines in the source code without any matches to the third party source.

7. The method of claim 1, further comprising:
accessing at least a portion of previous source code analysis results from the source code analysis tool, wherein each of the previous source code analysis results contains a date;
matching the previous source code analysis results with different dates on a same file of the source code; and
in response to the source code analysis results of the filtering module not matching the previous source code analysis results of the filtering module before a settable period of time, the filtering output of the filtering module includes the subset of the source code analysis results with any lines in the source code without any matches to the previous source code analysis results.

8. The method of claim 7, wherein the matching further comprises matching previous source code analysis results with different dates if the previous source code analysis results are located on a same line in a same file of source code.

9. The method of claim 8, wherein the matching further comprises matching the previous source code analysis results with different dates on a same file of the source code when textual contents of the previous source code analysis results are equivalent.

10. A computer program product comprising a computer readable storage medium having computer readable program code embodied therewith, the computer readable program code configured for:
accessing at least a portion of source code;
running a source code analysis tool on a computer system, wherein the source code analysis tool uses the portion of source code as an input and producing as an output a set of source code analysis results; and
running a filtering module using as a filtering input the set of source code analysis results, wherein the filtering module produces as a filtering output, a subset of the source code analysis results, using a filtering criteria related to the source code.

11. The computer program product of claim 10, further comprising:
running a plurality of filtering modules coupled together in series with a first filtering output of a first filtering module used as a second filtering input of a second filtering module, thereby producing a series filtering output using both the first filtering module and the second filtering module.

12. The computer program product of claim 10, further comprising:
retrieving a list of changes to the source code from a version control system, wherein each change in the list of changes includes a unique identifier, a set of files related to each change, a date, and an identifier associated with a user making the change.

13. The computer program product of claim 12, wherein the filtering output of the filtering module includes the subset of the source code analysis results within a settable period of time.

14. The computer program product of claim 12, wherein the filtering output of the filtering module includes the subset of the source code analysis results with a number of identifiers associated with distinct users making the change being greater than a settable number.

15. The computer program product of claim 10, further comprising:
accessing at least a portion of third-party source code;
identifying one or more line of programming code in the source code that have a matching line of programming code in the third-party source code; and
in response to lines in the source code not matching any lines in the third-party source code, the filtering output of the filtering module includes the subset of the source code analysis results with any lines in the source code without any matches to the third party source.

16. The computer program product of claim 10, further comprising:
accessing at least a portion of previous source code analysis results from the source code analysis tool, wherein each of the previous source code analysis results contains a date;
matching the previous source code analysis results with different dates on a same file of the source code; and
in response to the source code analysis results of the filtering module not matching the previous source code analysis results of the filtering module before a settable period of time, the filtering output of the filtering module includes the subset of the source code analysis results with any lines in the source code without any matches to the previous source code analysis results.

17. A system comprising:
memory;
at least one processor communicatively coupled to the memory, and together configured for:
accessing at least a portion of source code;
running a source code analysis tool on a computer system, wherein the source code analysis tool uses the portion of source code as an input and producing as an output a set of source code analysis results; and
running a filtering module using as a filtering input the set of source code analysis results, wherein the filtering module produces as a filtering output, a subset of the source code analysis results, using a filtering criteria related to the source code.

18. The system of claim 17, further comprising:
running a plurality of filtering modules coupled together in series with a first filtering output of a first filtering module used as a second filtering input of a second filtering module, thereby producing a series filtering output using both the first filtering module and the second filtering module.

19. The system of claim 18, further comprising:
retrieving a list of changes to the source code from a version control system, wherein each change in the list of changes includes a unique identifier, a set of files related to each change, a date, and an identifier associated with a user making the change.

20. The system of claim 19, wherein the filtering output of the filtering module includes the subset of the source code analysis results within a settable period of time.
